(19) United States
(12) Patent Application Publication
(10) Pub. No.: US 2008/0153463 A1
(43) Pub. Date: Jun. 26, 2008

(54) METHOD AND SYSTEM FOR INDICATING THE OCCURRENCE OF AN EVENT

(76) Inventor: Robert P. Morris, Raleigh, NC (US)

Correspondence Address: SCENERA RESEARCH, LLC, 111 CORNING RD., SUITE 220, CARY, NC, 27511, US

(21) Appl. No.: 11/614,216

(22) Filed: Dec. 21, 2006

(51) Int. Cl. H04M 3/537

(52) U.S. Cl. 455/412.2

(57) ABSTRACT

A method and system are disclosed for indicating the occurrence of an event. According to an exemplary embodiment, a method is described for indicating the occurrence of an event. The method includes receiving an event message including an event identifier identifying an event that has occurred. The method also includes determining a recipient of a notification message indicating the occurrence of the event. The method further includes identifying non-visual content for non-visual presentation associated with the occurrence of the event. The method still further includes sending the notification message including the non-visual content to an agent associated with the recipient without including visual information for visual presentation in the notification message that identifies the occurrence of the event, allowing the agent to automatically present the non-visual content to the recipient to indicate the occurrence of the event.

### RELATED APPLICATIONS

The subject matter of this application is related to U.S. patent application Ser. No. 11/______, titled “METHODS AND SYSTEMS FOR INDICATING THE OCCURRENCE OF AN EVENT” (Attorney Docket No. 1474/US), filed on even date with this application, the related application being commonly owned by the owner of this application, the entire disclosure of which is here incorporated by reference.

### BACKGROUND

Many events and transactions occur in the world that users would like to know about, but would be overwhelmed by phone calls and messages, such as email, for each of those events.

For example, consider the case of Mike and his mother. Mike's mother would like to know that he is home safe from school each day. Mike has to call his mother at work everyday on her mobile phone to let her know he is home from school. This is disruptive to her work since she may often be on the phone with a business associate.

Alternatively, Mike can send SMS messages indicating he is home, but this requires Mike's mother to stop what she is doing when her phone indicates that a message has been received to review the message. Her mobile phone provides an indication that an SMS message has been received, but it does not tell her what the meaning or content of the message is. Mike's mother has to open her message inbox, select the message, and view it to see that Mike has arrived safely at home. Afterwards, Mike's mother must cleanup her inbox by manually deleting the message.

Accordingly, there exists a need for a method, system, and computer program product for indicating the occurrence of an event.

### SUMMARY

Accordingly, a method and system are disclosed for indicating the occurrence of an event. According to an exemplary embodiment, a method is described for indicating the occurrence of an event. The method includes receiving an event message including an event identifier identifying an event that has occurred. The method also includes determining a recipient of a notification message indicating the occurrence of the event. The method further includes identifying non-visual content for non-visual presentation associated with the occurrence of the event. The method still further includes sending the notification message including the non-visual content to an agent associated with the recipient without including visual information for visual presentation in the notification message that identifies the occurrence of the event, allowing the agent to automatically present the non-visual content to the recipient to indicate the occurrence of the event.

According to another exemplary embodiment, a system is described for indicating the occurrence of an event. The system includes a notification handler configured to receive an event message including an event identifier identifying an event that has occurred. The system further includes an event-content mapper configured to identify non-visual content associated with the occurrence of the event; The notification handler is further configured to determine a recipient of a notification message indicating the occurrence of the event, and send the notification message including the non-visual content for non-visual presentation to an agent associated with the recipient without including visual information for visual presentation in the notification message that identifies the occurrence of the event, allowing the agent to automatically present the non-visual content to the recipient to indicate the occurrence of the event

### BRIEF DESCRIPTION OF THE DRAWINGS

The accompanying drawings provide visual representations which will be used to more fully describe the representative embodiments disclosed here and can be used by those skilled in the art to better understand them and their inherent advantages. In these drawings, like reference numerals identify corresponding elements, and:

FIG. 1 is a flowchart illustrating a method for indicating the occurrence of an event, according to an exemplary embodiment;

FIG. 2 illustrates a system for indicating the occurrence of an event according to an exemplary embodiment;

FIG. 3 illustrates a system for indicating the occurrence of an event, according to an exemplary embodiment; and

FIG. 4 is a data flow diagram illustrating the data flow in a method for indicating the occurrence of an event, according to an exemplary embodiment.

### DETAILED DESCRIPTION

Various aspects will now be described in connection with exemplary embodiments, including certain aspects described in terms of sequences of actions that can be performed by elements of a computing device or system. For example, it will be recognized that in each of the embodiments, at least some of the various actions can be performed by specialized circuits or circuitry (e.g., discrete and/or integrated logic gates interconnected to perform a specialized function), by program instructions being executed by one or more processors, or by a combination of both. Thus, the various aspects can be embodied in many different forms, and all such forms are contemplated to be within the scope of what is described.

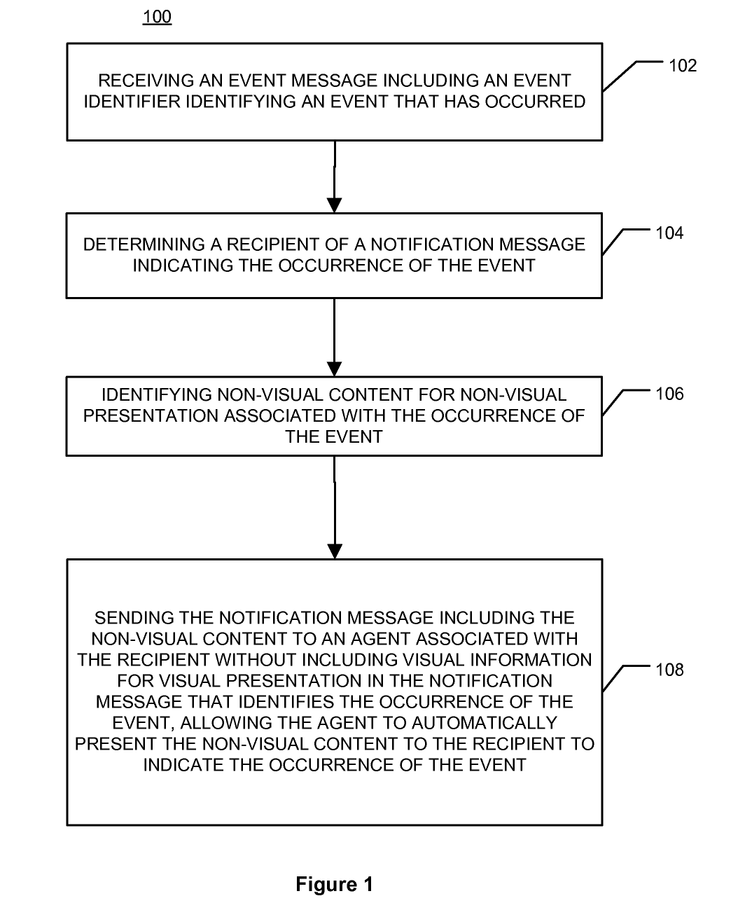

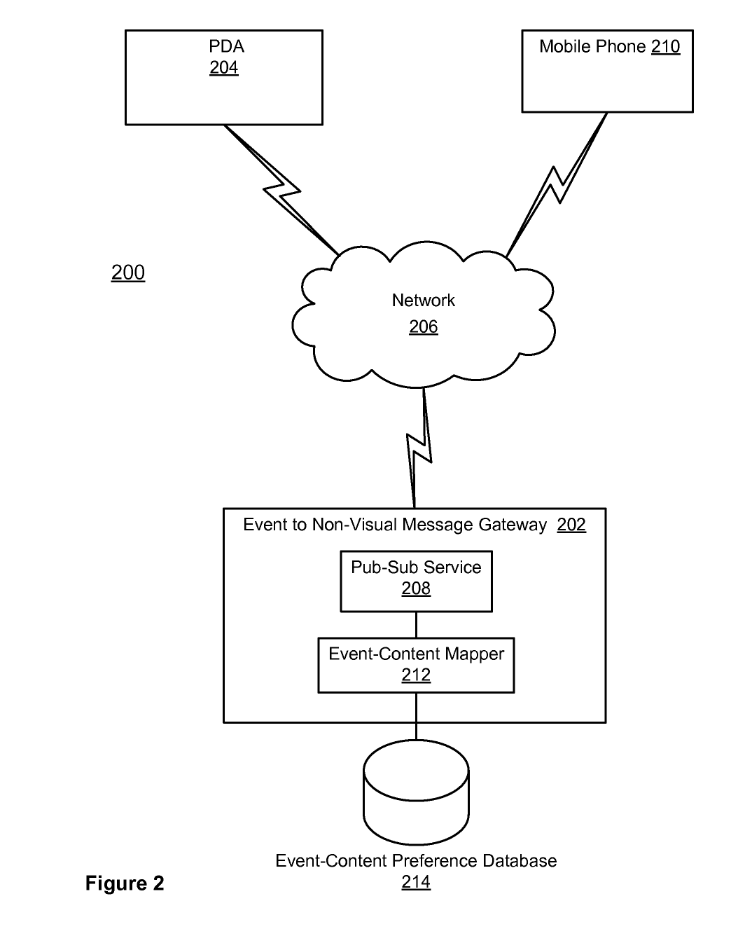

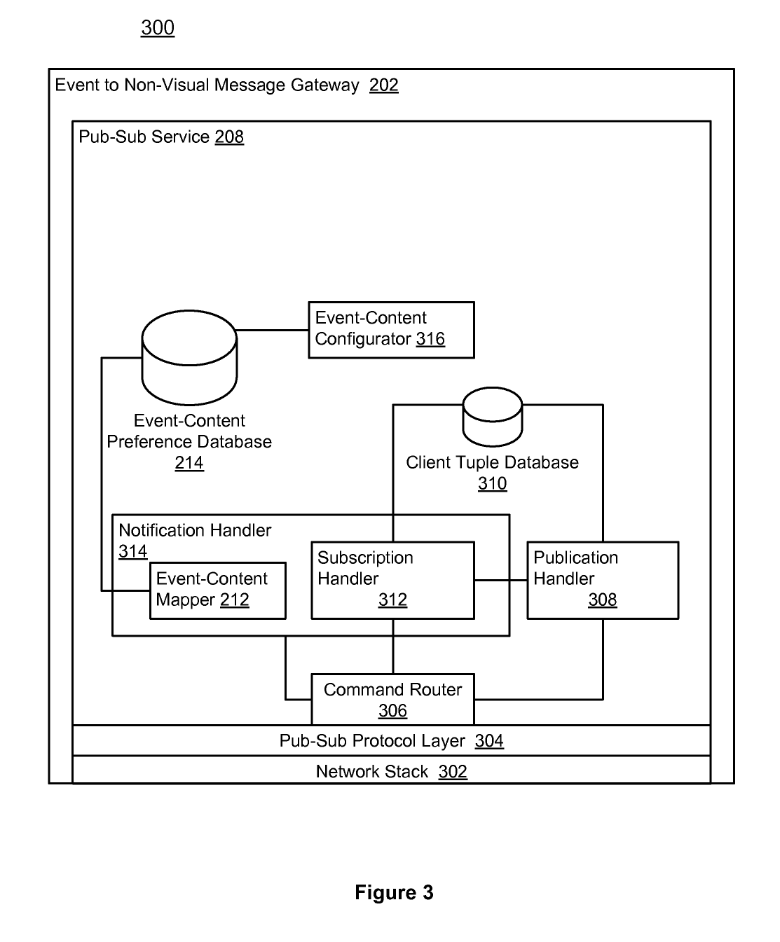

FIG. 1 depicts a flowchart illustrating an exemplary method 100 for indicating the occurrence of an event. The method can be carried out using the exemplary systems 200 and 300 depicted in FIGS. 2 and 3, portions of which are referenced below for illustration purposes.

A system for indicating the occurrence of an event according to an exemplary embodiment is shown in FIG. 2. The system 200 includes an event to non-visual message gateway 202 capable of performing the method 100. FIG. 3 depicts the system 300 that illustrates the event to non-visual message gateway 202 in more detail. The systems 200 and 300 and each of its components are described in detail with respect to performing the method 100.

At block 102 of the method 100, an event message is received. The event message includes an event identifier identifying an event that has occurred. As used herein, an event is something that happens or occurs that is capable of being detected either directly of indirectly by a networked device. Examples of events can include a change in state or mode; a creation, deletion, and/or update of an entity; a passing of control from one entity to another; and an error or fault. An event may also serve as an indicator of a second event that will occur in the future, such as notice that a package will be delivered within the hour. As used herein, an event can include the sending of communication message from one user to another.

An exemplary system for carrying out the method 100 includes means for receiving an event message including an event identifier identifying an event that has occurred. For example, the event to non-visual message gateway 202 includes a notification handler 314 configured to receive an event message including an event identifier identifying an event that has occurred

In the system 200 an event is detected by a device, such as a Personal Digital Assistant (PDA) 204. For example, a recipient wants to know that the user of the PDA 204 arrives home from school safely on school days. The PDA 204 is configured to generate a message indicating that the PDA 204 user has arrived home safely when the PDA 204 user selects the specific message from a list of preconfigured messages. In one embodiment, a message includes an identifier that has been associated with the message that the PDA 204 user has arrived home safely.

When an event is detected by the PDA 204, an event message is generated. The event message is subsequently sent from the PDA 204 via a network 206, such as the Internet, to a server operating in the role of the event to non-visual message gateway 202. The server can transform an event message to a notification message including non-visual content for non-visual presentation that when presented conveys the meaning of message generated by the PDA 204 as a result of the detected event

In the system 200, the gateway 202 can use a “publish-subscribe” (pub-sub) service 208 that receives messages indicating the event occurrences using a “publish-subscribe” protocol. A presence service is a type of pub-sub service, thus the pub-sub service 208 can be a presence service in some cases. Alternatively, the system may use any protocol and service enabling the receiving of messages indicating event occurrences and sending messages notifying clients of the event occurrences using non-visual content.

FIG. 3 depicts the system 300 illustrating a detailed depiction of the gateway 202. The event message is received by the gateway 202 via a network stack 302 where each layer processes at least a portion of the message before passing it to a next layer. A notification handler 314, after the processing, is configured to receive the event message. The processing of a received message typically includes stripping of any layer specific headers and trailers in each frame of the message associated with each layer. The processing of the message to be transmitted can also include adding layer specific headers and trailers to each frame of the message.

A pub-sub protocol layer 304 can receive the event message, if the event message is in a publish command format. The pub-sub protocol layer 304 parses and validates pub-sub commands such as the publish command and provides the content of the message to an application operatively coupled to the pub-sub protocol layer 304. In the system 300, the publish command is passed to a command router 306 of the pub-sub service 208 using the pub-sub protocol layer 304.

The command router 304 can process incoming commands including routing commands based on the type of command. Publish commands can be routed to a publication handler 308 that updates a tuple associated with the publishing client in a client tuple database 310. Alternatively, the command information may not be stored in a database, rather it can be immediately processed, as will be described, and discarded. Only the most recently published information can be stored in a tuple associated with a publishing client consistent with the design of real-time publish-subscribe services. The message may, alternatively, be queued until a recipient is available for receiving information based on the message.

At block 104 of the method 100, a recipient of a notification message indicating the occurrence of the event is determined. The exemplary system for carrying out the method 100 includes means for determining a recipient of the notification message.

For example, the notification handler 314 is configured to determine the recipient of the notification message. The event message can include at least one of recipient information associated with the recipient of the notification message and source information associated with a source of the event message. The notification handler 314 can be configured to determine the recipient of the notification message using at least one of the recipient information, the source information, and the event identifier included in the event message to determine the recipient of the notification message.

In the notification handler 314, a subscription handler 312 can be configured to use at least one of the recipient information, the source information, and the event identifier to determine the recipient of the notification message as a subscriber in a subscription list, wherein the subscriber is associated with the at least one of the recipient information, the source information, and the event identifier.

The subscription handler 312 is notified when a tuple is updated either by the client tuple database 310 and/or by the publication handler 308. When a received message is a directed publish command, the subscription handler 312 invokes the notification handler 314 to generate a message to send to the identified recipient. The pub-sub service 208 may support directed publish commands in addition to a recipient identified in the message of the publish command. In this situation, the publication handler 308 publishes the source information to a source tuple, the recipient information to a recipient tuple, the event indicator to an event tuple. The recipient information and/or the source information can include at least one of a status, a location, and an entity associated with event

When the received message is a publish command without an identified recipient, the subscription handler 312 uses a subscriber list (not shown) stored in the client tuple database 310 to identify a member of the subscriber list as a recipient.

Alternatively, a recipient can be determined based on a request from a client. For example, the notification handler can be configured to use information included in a request message, requesting information about the event after the event message is received, to determine the recipient of the notification message. A client may poll the gateway 202 for a message associated with the occurrence of an event. Polling can be done for substantially real-time events and for queued events that are delivered when a client indicates an available recipient.

At block 106 of the method 100, non-visual content for non-visual presentation associated with the occurrence of the event is identified. The exemplary system for carrying out the method 100 includes means for identifying non-visual content associated with the occurrence of the event.

For example, an event-content mapper 212 is configured to identify non-visual content for non-visual presentation associated with the occurrence of the event. The non-visual content can include at least one of audio content and tactile content. The event-content mapper 212 and an associated event-content preference database 214 are depicted in the system 200. The event-content mapper 212 is also depicted as a component of the notification handler 314 in the system 300. When the notification handler 314 is invoked to generate a notification associated with a received message indicating the occurrence of an event, the notification handler 314 passes information identifying the indicated event to the event-content mapper 212. The event-content mapper 212 can perform a lookup using the event-content preference database 214 to identify non-visual content that is associated with the occurrence of the indicated event.

The event-content preference database 214 can include an association of the event identifier with information associated with at least one of a recipient of the notification message, a source of the event message, an entity associated with an occurrence of an event, a time associated with an occurrence of an event, a duration associated with an occurrence of an event, a capability of at least one of a recipient and a recipient's agent to process non-visual content, and a status of an entity associated with the occurrence of an event; and wherein the event-content mapper is configured to query the event-content preference database 214 for content associated with the event identifier.

An association between a particular event and a particular non-visual content can be specified as a standard. The standard makes the association universal for all recipients of gateway 202 and/or clients 204 and 210 that adhere to the standard. The scope of a standard varies where a scope, for example, is worldwide; company specific; industry specific; specific to other types of groups including a family, a professional group, and/or a hobby or enthusiasts group; and/or specific to a location including a country, a county, a city, a neighborhood, a company site, and/or a home.

An association between a particular event and a particular non-visual content in some cases is individualized forming a standard for a group of one. The recipient in some cases is allowed to configure the association between an event and a particular non-visual content. Instead of describing an association in terms of a standard, the specification of the association can be described as customized for an individual, a group, a country, and/or for the world, for example.

The recipient of the notification message is allowed by the gateway to configure an association between the indicated event and non-visual content of her choosing, such as vibration pattern and/or an audio tone or clip. Thus, recipient of the notification message associates the vibration pattern and/or the audio content selected with the message thus associating the message that the PDA 204 user has arrived home safely from school with the selected content. This configuration capability can be provided by an event-content configurator 316 that provides an interface on at least one of the gateway and the mobile phone 210 allowing recipient of the notification message to specify the association of the event with the non-visual content.

The event-content mapper 212 may be separate from the pub-sub server 208 and, in some cases, hosted in a separate device. Similarly, the event-content preference database 214 can be a tuple database and be included in the client tuple database 310. Further, the event-content preference database 214 can be hosted in a networked device remote from the gateway 202 and in some cases is remote from the event-mapper 212. Events can be associated with non-visual content using a variety of. In one example, the association is between an event identifier and a non-visual content identifier making the association common for all recipients.

At block 108 of the method 100, the notification message including the non-visual content is sent to an agent associated with the recipient without including visual information for visual presentation in the notification message that identifies the occurrence of the event. The notification message allows the agent to automatically present the non-visual content to the recipient to indicate the occurrence of the event. The exemplary system for carrying out method 100 includes means for sending the notification message including the non-visual content to an agent associated with the recipient without including visual information for visual presentation in the notification message that identifies the occurrence of the event, allowing the agent to automatically present the non-visual content to the recipient to indicate the occurrence of the event.

For example, the notification handler 314 is configured to send the notification message to an agent associated with the recipient. The notification handler 314 can be configured to generate the notification message including the non-visual content. Once the event-content mapper 212 identifies the non-visual content, control is returned to the notification handler 314 for generating a notification message. The notification handler 314 can be configured to send the notification message to the agent of the recipient in a manner that allows the agent to automatically present the non-visual content to the recipient substantially in real-time in relation to the occurrence of the event and/or automatically present the non-visual content to the recipient when the recipient is determined to be available for perceiving the non-visual content. The notification message may, alternatively, be sent only if the agent, the mobile phone 210, and/or the recipient, is determined to be available for receiving the notification. For example, a presence service can be used to track the status of agents and recipients.

As discussed above, the notification handler 314 can be configured to generate the notification message including non-visual content without including visual information. The non-visual content is associated with, and thus identifies, the occurrence of the event indicated in the event message received by the gateway 202.

The notification message can also include retention information. Retention information as used herein is information included in a message that affects the storage of a message received by a device. The retention information can cause a notification message to be deleted in association with the presenting of the non-visual content. The retention information included in a notification message can be a command code or a representation of an instruction such as a script or command identifier that a receiver of the message uses in determining whether to retain a message, where to retain it, and/or in what format to retain it.

The retention information included in the message can include a retention period defining a period after the occurrence of the event, after which, the notification message is to be automatically deleted. The retention information can includes a deletion instruction causing the notification message is to be automatically deleted in association with the presentation of the non-visual content. The deletion instruction may be a command code or a representation of an instruction such as a script or command identifier that a receiver of the message uses in determining whether to retain a message, where to retain it, and/or in what format to retain it.

Retention information causes an agent of a recipient, such as the mobile phone 210 to delete and/or not save the notification message in association with presenting at least a portion of the non-visual content to the recipient. For example, the notification message can be deleted from storage after the visual content is copied and just before it is presented and the copied content is not saved to persistent storage, rather its run-time storage is reused. The message and the non-visual content of the message can both be deleted and/or not saved after the non-visual content has been presented.

The notification message is sent to an agent of the identified recipient. In the embodiment and example described, the notification handler 314 sends a message including a notify command to an agent, the mobile phone 210, of the recipient. The message includes the non-visual content associated by the recipient with occurrences of the event of the PDA user's safe arrival home from school, where the association is made using the event-content configurator 316 of the gateway 202.

The agent, the mobile phone 210, can automatically present the non-visual content included in the message. The non-visual content can be presented automatically when the message is received in substantially real-time. Alternatively, the non-visual content can be presented automatically when the recipient is determined to be available for perceiving the non-visual content. For example, the agent causes the mobile phone 210 to vibrate in pattern recognizable to the recipient. The non-visual content may also be if the form of an audio tone or clip that the recipient associates with the message.

Some of the blocks of the method 100, including determining the recipient, identifying the non-visual content, and sending the notification message can occur under control of a device that does not include the agent and the device performs at least one of receiving the event message and generating the event message.

In an alternate embodiment of the system 200, the gateway 202 functionality can be included in the sender of the message indicating the occurrence of the event, such as the PDA 204. The receiving of the messaging indicating the occurrence of the event is performed using a means included in the sender. For example, the PDA 204 presents a list of pre-specified messages as discussed earlier. The PDA 204 can be enabled to receive a selection of a message from the list. This constitutes the receiving of a message indicating the occurrence of an event. The PDA 204 can include an event-content mapper 212 and an event-content preference database 214 that together identify a particular non-visual content associated with the occurrence of the event indicated by the received selection message.

Analogously, the PDA 204 can include a messaging agent (not shown) as the gateway 202 includes the notification handler 314. The PDA 204 can generate a message that is sent to a proxy, such as the gateway 202, identifying a recipient and relays the message to an agent, the mobile phone 210, of the recipient for processing as previously described. Further, the PDA 204 can determine the agent of the recipient, the mobile phone 210, and then send the message to the mobile phone 210. The PDA 204 may include a database for storing associations between particular events and particular recipients.

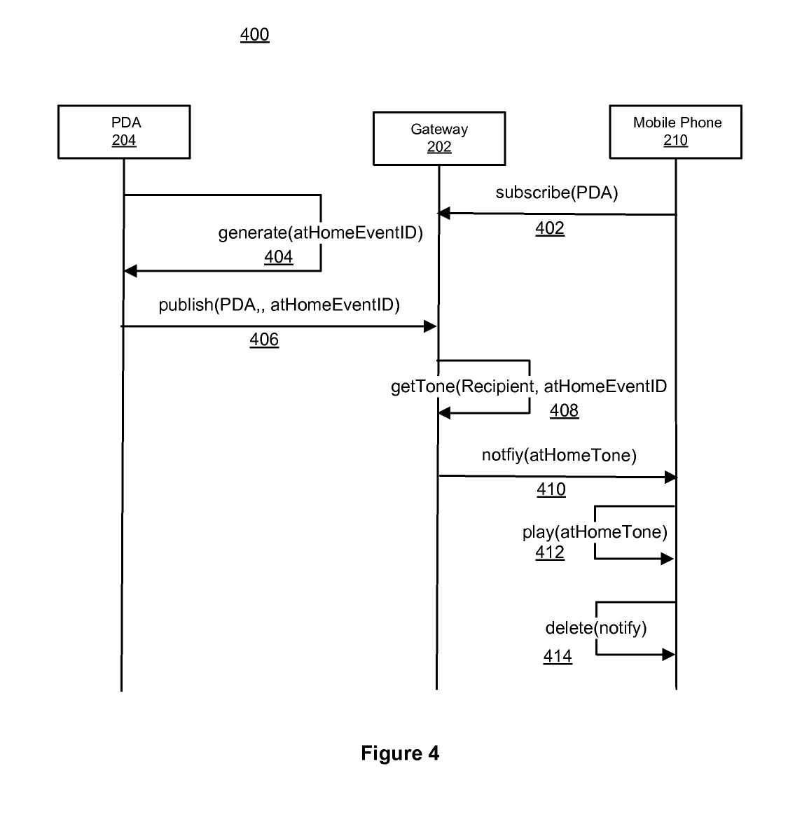

FIG. 4 illustrates a message flow diagram 400 illustrating an exemplary message flow between the PDA 204, the gateway 202, and the mobile phone 210 during the operation of the system 200 and the system 300 in carrying out the method 100. In the exemplary message flow 400, the mobile phone 210 sends a message 402 including a subscribe command to the gateway 202 for subscribing to a tuple in the client tuple database 310 associated with the PDA user as indicated by the subscribe parameter. The gateway 202 adds an entry in a subscriber list associated with the PDA user's tuple for the mobile phone 210.

The PDA 204 receives a message (not shown) via a user interface (not shown) of the PDA 204 including a selection indicating an occurrence of the event of the PDA user arriving safely home from school. Alternatively, the message may be automatically generated without user input. An event message 406 is generated including an “atHomeEventID” as a result of the message 404. The event message 406 includes a publish command indicating the occurrence of the event by the inclusion of the “atHomeEventID” in the message is sent to the gateway 202 An ID identifying the PDA 204 user's agent as the publisher is also included enabling the publication handler 308 to update a tuple associated with the PDA user's agent as a publisher. The message 406 is received by the gateway 202 and is processed as previously described including updating the tuple associated with the PDA user by the publication handler 308 in the client tuple database 310.

The subscription handler 312 is invoked to identify a recipient as previously described. The subscription handler 312 identifies the mobile phone 210 by its presence as a member of the subscriber list associated with the PDA 204 user's tuple. The notification handler 314 is invoked and subsequently requests the event-content mapper 212, as indicated by a message 408, to identify a non-visual content to convey the occurrence of the indicated event to the recipient via the identified agent of the recipient, the mobile phone 210. As a result of processing the message 408, a notification message 410 is generated by the notification handler 314 of the gateway 202. The notification message 410 includes the non-visual content identified by the event-content mapper 212. The notification message 410 is sent to the agent, the mobile phone 210, of the recipient.

As previously described, the notification message 410 includes the non-visual content without any visual content that identifies the occurrence of the event. The non-visual content is indicated in the notification message 410 by the “atHomeTone” parameter that is an audio stream for playing a tone that the recipient interprets to mean that the PDA 204 user has arrived home safely from school. The “atHome Tone” is played by the mobile phone 210 at 412. If the notification message includes retention information as described above, then the notification message is deleted at 414.

The executable instructions of a computer program as illustrated in FIG. 1 for indicating the occurrence of an event can be embodied in any computer readable medium for use by or in connection with an instruction execution system, apparatus, or device, such as a computer based system, processor containing system, or other system that can fetch the instructions from the instruction execution system, apparatus, or device and execute the instructions.

As used here, a “computer readable medium” can be any means that can contain, store, communicate, propagate, or transport the program for use by or in connection with the instruction execution system, apparatus, or device. The computer readable medium can be, for example, but not limited to, an electronic, magnetic, optical, electromagnetic, infrared, or semiconductor system, apparatus, device, or propagation medium. More specific examples (a non-exhaustive list) of the computer readable medium can include the following: a wired network connection and associated transmission medium, such as an ETHERNET transmission system, a wireless network connection and associated transmission medium, such as an IEEE 802.11(a), (b), or (g) or a BLUETOOTH transmission system, a wide-area network (WAN), a local-area network (LAN), the Internet, an intranet, a portable computer diskette, a random access memory (RAM), a read only memory (ROM), an erasable programmable read only memory (EPROM or Flash memory), an optical fiber, a portable compact disc (CD), a portable digital video disc (DVD), and the like.

It will be appreciated by those of ordinary skill in the art that the concepts and techniques described here can be embodied in various specific forms without departing from the essential characteristics thereof. The presently disclosed embodiments are considered in all respects to be illustrative and not restrictive. The scope of the invention is indicated by the appended claims, rather than the foregoing description, and all changes that come within the meaning and range of equivalence thereof are intended to be embraced.

What is claimed is:

1. A method for indicating the occurrence of an event, the method comprising:
receiving an event message including an event identifier identifying an event that has occurred;
determining a recipient of a notification message indicating the occurrence of the event;
identifying non-visual content for non-visual presentation associated with the occurrence of the event; and
sending the notification message including the non-visual content to an agent associated with the recipient without including visual information for visual presentation in the notification message that identifies the occurrence of the event, allowing the agent to automatically present the non-visual content to the recipient to indicate the occurrence of the event.

2. The method of claim 1, wherein the event identifier includes a character string used in identifying the event that has occurred.

3. The method of claim 1, wherein the event message includes at least one of recipient information associated with the recipient of the notification message and source information associated with a source of the event message.

4. The method of claim 3, wherein determining the recipient of the notification message comprises using at least one of the recipient information, the source information, and the event identifier to determine the recipient of the notification message.

5. The method of claim 3, comprising using at least one of the recipient information, the source information, and the event identifier to determine the recipient of the notification message as a subscriber in a subscription list, wherein the subscriber is associated with the at least one of the recipient information, the source information, and the event identifier.

6. The method of claim 3, wherein at least one of the recipient and source information includes at least one of a status, a location, and an entity associated with event.

7. The method of claim 1, wherein determining the recipient of the notification message comprises using information included in a request message, requesting information about the event after the event message is received, to determine the recipient of the notification message.

8. The method of claim 1, wherein identifying non-visual content for non-visual presentation associated with the occurrence of the event is based on an association of the event identifier with information associated with at least one of a recipient of the notification message, a source of the event message, an entity associated with an occurrence of an event, a time associated with an occurrence of an event, a duration associated with an occurrence of an event, a capability of at least one of a recipient and a recipient's agent to process non-visual content, and a status of an entity associated with the occurrence of an event.

9. The method of claim 1, comprising generating the notification message including the non-visual content.

10. The method of claim 1, wherein the notification message is sent to the agent of the recipient in a manner that allows the agent to at least one of:
automatically present the non-visual content to the recipient substantially in real-time in relation to the occurrence of the event; and
automatically present the non-visual content to the recipient when the recipient is determined to be available for perceiving the non-visual content.

11. The method of claim 1, wherein the non-visual content includes at least one of audio content and tactile content.

12. The method of claim 1, wherein the notification message includes retention information including a retention period defining a period after the occurrence of the event, after which, the notification message is to be automatically deleted.

13. The method of claim 12, wherein the retention information includes a deletion instruction indicating the notification message is to be automatically deleted in association with the presentation of the non-visual content.

14. The method of claim 1, wherein determining the recipient, identifying the non-visual content, and sending the notification message occur under control of a device that does not include the agent and the device performs at least one of receiving the event message and generating the event message.

15. A system for indicating the occurrence of an event, the system comprising:
a notification handler configured to receive an event message including an event identifier identifying an event that has occurred;
an event-content mapper configured to identify non-visual content for non-visual presentation associated with the occurrence of the event; wherein, the notification handler is configured to determine a recipient of a notification message indicating the occurrence of the event, and send the notification message including the non-visual content to an agent associated with the recipient without including visual information for visual presentation in the notification message that identifies the occurrence of the event, allowing the agent to automatically present the non-visual content to the recipient to indicate the occurrence of the event.

16. The system of claim 15, wherein the event identifier includes a character string used in identifying the event that has occurred.

17. The system of claim 15, wherein the event message includes at least one of recipient information associated with the recipient of the notification message and source information associated with a source of the event message.

18. The system of claim 17, wherein the notification handler is configured to use at least one of the recipient information, the source information, and the event identifier to determine the recipient of the notification message.

19. The system of claim 17, comprising a subscription handler configured to use at least one of the recipient information, the source information, and the event identifier to determine the recipient of the notification message as a subscriber in a subscription list, wherein the subscriber is associated with the at least one of the recipient information, the source information, and the event identifier.

20. The system of claim 17, wherein at least one of the recipient and source information includes at least one of a status, a location, and an entity associated with event.

21. The system of claim 15, wherein the notification handler is configured to use information included in a request message, requesting information about the event after the event message is received, to determine the recipient of the notification message.

22. The system of claim 15, comprising an event-content preference database including an association of the event identifier with information associated with at least one of a recipient of the notification message, a source of the event message, an entity associated with an occurrence of an event, a time associated with an occurrence of an event, a duration associated with an occurrence of an event, a capability of at least one of a recipient and a recipient's agent to process non-visual content, and a status of an entity associated with the occurrence of an event; and wherein the event-content mapper is configured to query the event-content preference database for content associated with the event identifier.

23. The system of claim 15, wherein the notification handler is configured to send the notification message to the agent of the recipient in a manner that allows the agent to at least one of:
automatically present the non-visual content to the recipient substantially in real-time in relation to the occurrence of the event; and
automatically present the non-visual content to the recipient when the recipient is determined to be available for perceiving the non-visual content.

24. The system of claim 15, wherein the non-visual content includes at least one of audio content and tactile content.

25. The system of claim 15, wherein the notification message includes retention information including a retention period defining a period after the occurrence of the event, after which, the notification message is to be automatically deleted.

26. The system of claim 25, wherein the retention information includes a deletion instruction indicating the notification message is to be automatically deleted in association with the presentation of the non-visual content.

27. A computer readable medium containing a computer program, executable by a machine, for indicating the occurrence of an event, the computer program comprising executable instructions for:
receiving an event message including an event identifier identifying an event that has occurred;
determining a recipient of a notification message indicating the occurrence of the event;
identifying non-visual content for non-visual presentation associated with the occurrence of the event; and
sending the notification message including the non-visual content to an agent associated with the recipient without including visual information for visual presentation in the notification message that identifies the occurrence of the event, allowing the agent to automatically present the non-visual content to the recipient to indicate the occurrence of the event.

28. A system for indicating the occurrence of an event, the system comprising:
means for receiving an event message including an event identifier identifying an event that has occurred;
means for determining a recipient of a notification message indicating the occurrence of the event;
means for identifying non-visual content for non-visual presentation associated with the occurrence of the event; and
means for sending the notification message including the non-visual content to an agent associated with the recipient without including visual information for visual presentation in the notification message that identifies the occurrence of the event, allowing the agent to automatically present the non-visual content to the recipient to indicate the occurrence of the event.
